(19) United States
(12) Patent Application Publication
(10) Pub. No.: US 2021/0392966 A1
(43) Pub. Date: Dec. 23, 2021

(54) FACE COVERINGS FOR USE WITH MOUTHGUARDS AND GARMENTS INCLUDING SUCH FACE COVERINGS

(71) Applicant: Shock Doctor, Inc., Fountain Valley, CA (US)

(72) Inventor: Tri Minh Nguyen, Tustin, CA (US)

(21) Appl. No.: 17/349,213

(22) Filed: Jun. 16, 2021

Related U.S. Application Data
(60) Provisional application No. 63/040,168, filed on Jun. 17, 2020.

(51) Int. Cl. A41D 13/11

(52) U.S. Cl. CPC A41D 13/1107

(57) ABSTRACT

A face covering is configured to obscure the nose and the mouth of a wearer. The face covering includes an upper portion including a free lower edge and a lower portion coupled to the upper portion, and the lower portion includes a free upper edge. The free lower edge and the free upper edge are relatively movable to provide an opening therebetween, and the opening is configured to permit a mouthguard to pass through the face covering.

### CROSS-REFERENCE TO RELATED APPLICATION

The present application claims the benefit of and priority to, under 35 U.S.C. § 119(e), U.S. Provisional Application Ser. No. 63/040,168, filed on Jun. 17, 2020, which is hereby incorporated herein by reference in its entirety for all that it teaches and for all purposes.

### TECHNICAL FIELD

The present invention relates to face coverings for obscuring a wearer's mouth and/or nose. More specifically, the present invention relates to face coverings that facilitate use of mouthguards for protecting a wearer's mouth during physical activities.

### BACKGROUND

Face coverings are typically used to obscure a wearer's mouth and/or nose and thereby reduce transmission of infectious disease. Mouthguards are typically used to protect a wearer's teeth, oral tissue, and gums from impact and abrasion. Mouthguards may reduce the chance of shock and other injuries resulting from impacts during athletic activities.

### SUMMARY

In one aspect, the present disclosure provides a face covering that is configured to obscure the nose and the mouth of a wearer. The face covering includes an upper portion including a free lower edge and a lower portion coupled to the upper portion, and the lower portion includes a free upper edge. The free lower edge and the free upper edge are relatively movable to provide an opening therebetween, and the opening is configured to permit a mouthguard to pass through the face covering.

In certain embodiments, the free lower edge has a width in a transverse direction in a range of 5 inches to 7 inches.

In certain embodiments, the free upper edge is disposed superiorly relative to the free lower edge.

In certain embodiments, a garment includes the face covering, and the garment is at least one of a mask, a balaclava, a neck gaiter, and a shirt.

In certain embodiments, the garment includes a posterior portion coupled to the face covering, and the posterior portion is configured to be disposed behind the head of the wearer.

In another aspect, the present disclosure provides a face covering that is configured to obscure the nose and the mouth of a wearer. The face covering includes a lower panel and an upper panel partially overlapping the lower panel. The lower panel and the upper panel are relatively movable to provide an opening therebetween, and the opening is configured to permit a mouthguard to pass through the face covering.

In certain embodiments, the opening has a width in a transverse direction in a range of 5 inches to 7 inches.

In certain embodiments, a garment includes the face covering, and the garment is at least one of a mask, a balaclava, a neck gaiter, and a shirt.

In certain embodiments, the garment includes a posterior portion coupled to the face covering, and the posterior portion is configured to be disposed behind the head of the wearer.

In yet another aspect, the present disclosure provides a face covering that is configured to obscure a nose and a mouth of a wearer. The face covering includes a first fabric panel having a first free edge and a second fabric panel having a second free edge. The first free edge is positioned anteriorly of the second free edge in an overlapping manner, and the first fabric panel and the second fabric panel are cooperatively positioned to obscure a nose and mouth of the wearer when in use. The first free edge and the second free edge are relatively movable to provide an opening therebetween, and the opening is configured to permit a mouthguard to pass through the face covering. The face covering further includes a posterior portion coupled to the first fabric panel and the second fabric panel, and the posterior portion is configured to be disposed behind the head of the wearer.

In certain embodiments, the first fabric panel is disposed superiorly relative to the second fabric panel.

In certain embodiments, the first fabric panel is disposed inferiorly relative to the second fabric panel.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a side view of a mask including a face covering according to an embodiment of the present disclosure; the face covering is shown in a closed configuration, and a wearer of the mask is shown in phantom lines;

FIG. 2 is another side view of the mask of FIG. 1;

FIG. 3 is a side perspective view of the mask of FIG. 1;

FIG. 4 is a front view of the mask of FIG. 1; an upper edge of a lower portion of the face covering is shown in phantom lines;

FIG. 5 is another side view of the mask of FIG. 1 with the face covering in the closed configuration;

FIG. 6 is a side view of the mask of FIG. 1 with the face covering in an open configuration; and

FIG. 7 is a top view of a pattern from which portions of the mask of FIG. 1 may be formed.

It should be understood that the drawings are intended facilitate understanding of exemplary embodiments of the present invention are not necessarily to scale.

### DETAILED DESCRIPTION OF THE DRAWINGS

The following description refers to the accompanying drawings which show specific embodiments. Although specific embodiments are shown and described, it is to be understood that additional or alternative features are employed in other embodiments. The following detailed description is not to be taken in a limiting sense, and the scope of the claimed invention is defined by the appended claims and their equivalents.

It should be understood that like reference numerals are intended to identify the same structural components, elements, portions, or surfaces consistently throughout the several drawing figures, as such components, elements, portions, or surfaces may be further described or explained by the entire written specification, of which this detailed description is an integral part. Unless otherwise indicated, the drawings are intended to be read (for example, cross-hatching, arrangement of parts, proportion, degree, etc.) together with the specification, and are to be considered a portion of the written description. In the description, the terms “forward”, “front”, “rearward”, “rear”, “upper”, “lower”, “forward”, “rearward”, “lateral”, and “horizontal” as well as variations thereof (for example, “superiorly” and the like) are used to describe relative positions of features of face coverings. Such terms refer to anatomical reference directions when a face covering is positioned on a wearer's face in a typical orientation.

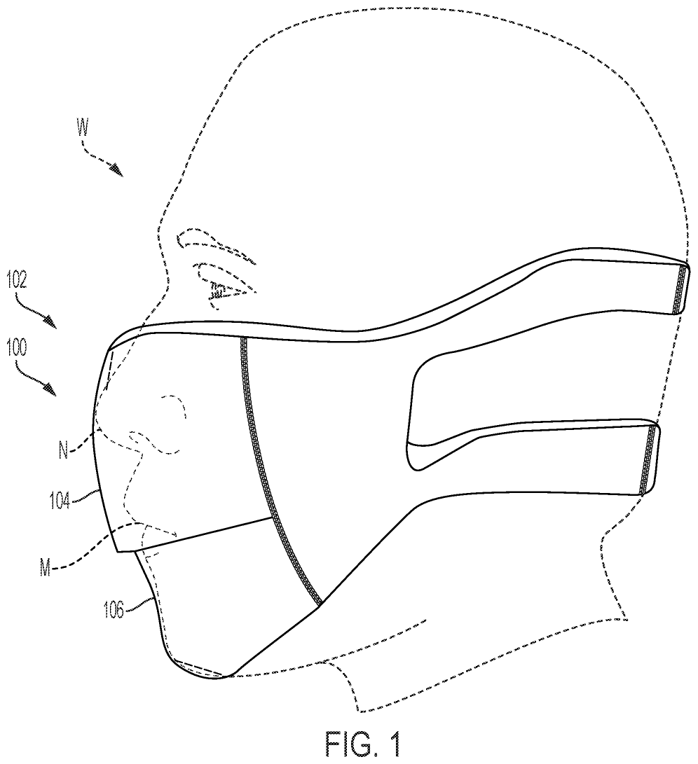

FIG. 1 illustrates a face covering 100 according to an embodiment of the present disclosure being worn on the face of a wearer W. The face covering 100 forms a portion of a garment 102, which is illustratively shown as a face mask. In other embodiments, the garment 102 may take other forms, such as a balaclava, a neck gaiter, or a collared shirt (not shown). Generally, the face covering 100 includes an upper portion 104, also referred to as an upper panel, and a lower portion 106, also referred to as a lower panel. The upper portion 104 is configured to be disposed adjacent the nose N of the wearer W, and the lower portion 106 is configured to be disposed adjacent the mouth M of the wearer W. As described in further detail below, the upper portion 104 and the lower portion 106 are movable apart from each other to selectively define an opening in the face covering 100. The opening permits a mouthguard to pass through the face covering 100 and thereby enter or exit the mouth M of the wearer W.

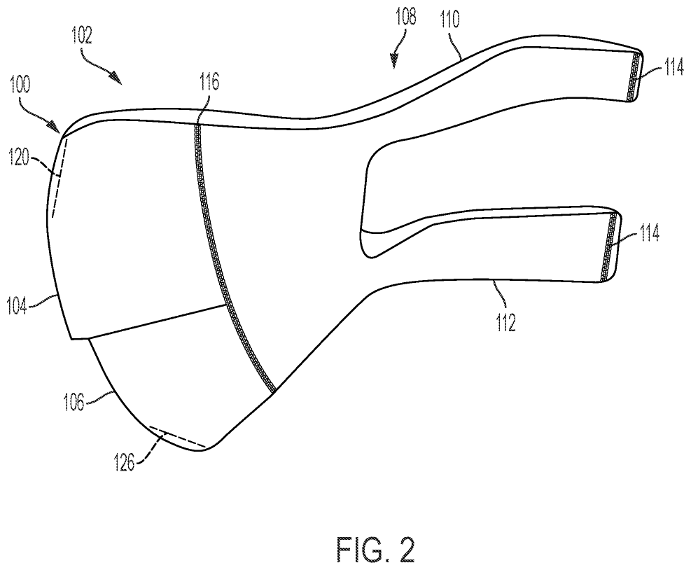

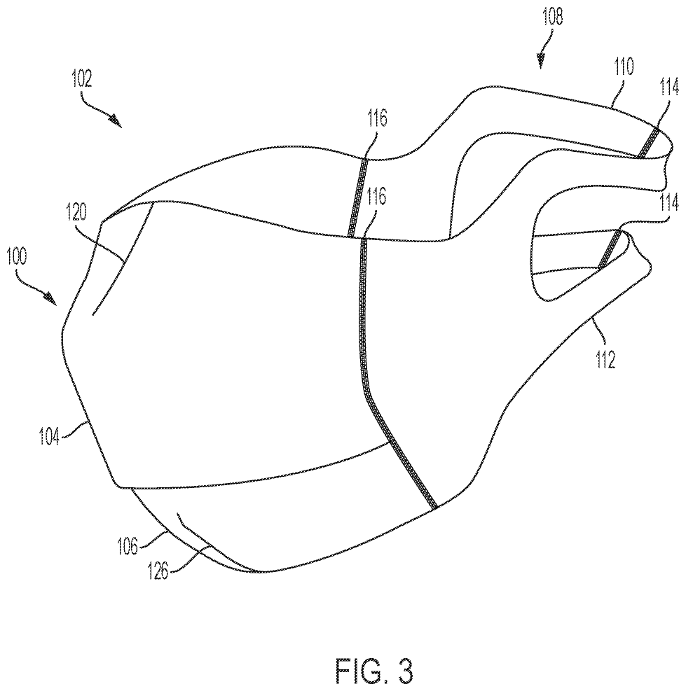

FIGS. 2-4 further illustrate the face covering 100 and the garment 102. As illustrated, the face covering 100 forms anterior portion of the garment 102, and the garment 102 further includes a posterior portion 108 coupled to the face covering 100. The posterior portion 108 is configured to be disposed behind the head of a wearer to secure the face covering 100 on the face of the wearer. In some embodiments and as illustrated, the posterior portion 108 includes an upper strap 110 and a lower strap 112. The upper strap 110 and the lower strap 112 both include opposite end portions that are coupled via stitched seams 114, more specifically, flatlock seams. In other embodiments, the posterior portion 108 may take other forms. For example, the posterior portion 108 may include a different number of straps, the strap(s) may have one or more selectively attachable/detachable end portions (for example, by carrying hook and loop fasteners), the straps may have a different shape (for example, being formed as earloops), or the posterior portion 108 may include a relatively tall, generally continuous section of material (for example, if the garment 102 is a balaclava, a neck gaiter, or a collared shirt).

With continued reference to FIGS. 2-4, the posterior portion 108 couples to opposite sides of the upper portion 104 and the lower portion 106 of the face covering 100. Illustratively, the posterior portion 108 couples to the sides of upper portion 104 and the lower portion 106 via stitched seams 116, more specifically, flatlock seams.

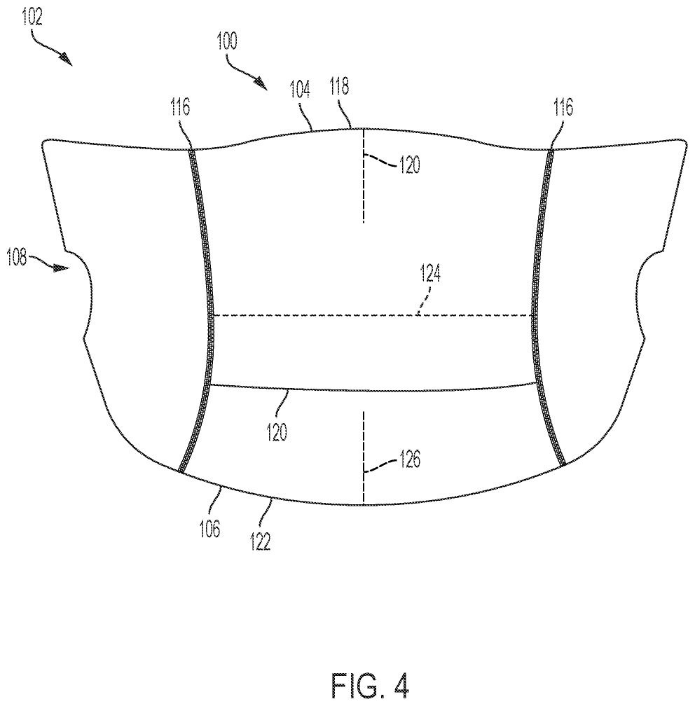

With specific reference to FIG. 4, the upper portion 104 of the face covering 100 extends from an upper edge 118 disposed apart from the lower portion 106 to a free lower edge 120 disposed adjacent the lower portion 106. Adjacent the upper edge 118, the upper portion 104 includes an upper dart 120 to shape the upper portion 104 to the nose of a wearer. The lower portion 106 of the face covering 100 extends from a lower edge 122 disposed apart from the upper portion 104 to a free upper edge 124 disposed adjacent the upper portion 104. Adjacent the lower edge 122, the lower portion 106 includes a lower dart 126 to shape the lower portion 106 to the chin of a wearer.

With continued specific reference to FIG. 4, the upper portion 104 and the lower portion 106 of the face covering 100 normally occupy a closed configuration to inhibit access to the mouth of a wearer. Stated another way, the upper portion 104 and the lower portion 106 normally partially overlap each other. More specifically, the free lower edge 120 of the upper portion 104 is normally disposed inferiorly relative to the free upper edge 124 of the lower portion 106, or the free upper edge 124 of the lower portion 106 is normally disposed superiorly relative to the free lower edge 120 of the upper portion 104.

In the illustrated embodiment, the free lower edge 120 of the upper portion 104 is disposed anteriorly or outwardly (relative to the face of the wearer) of the free upper edge 124 of the lower portion 106 in an overlapping manner. However, in embodiments, this configuration can be reversed; that is, the free upper edge 124 of the lower portion 106 can be disposed anteriorly of the free lower edge 120 of the upper portion 104.

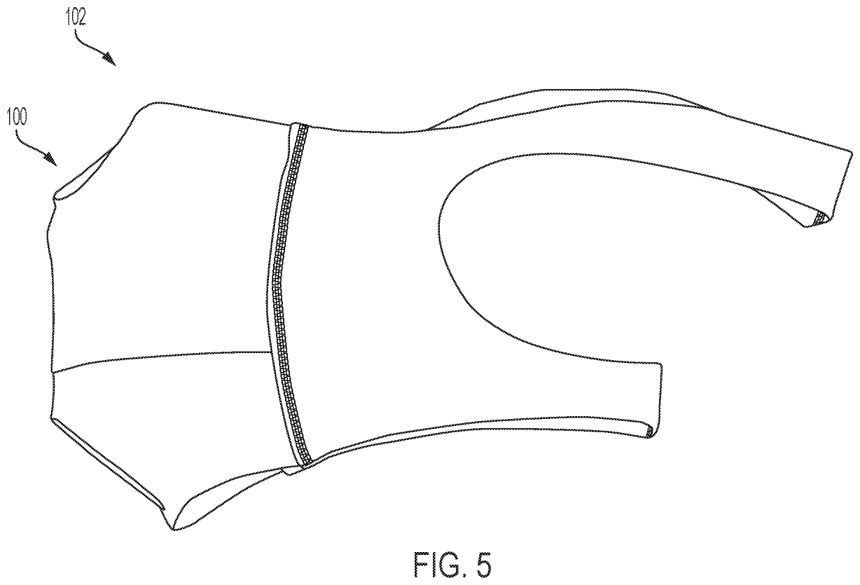

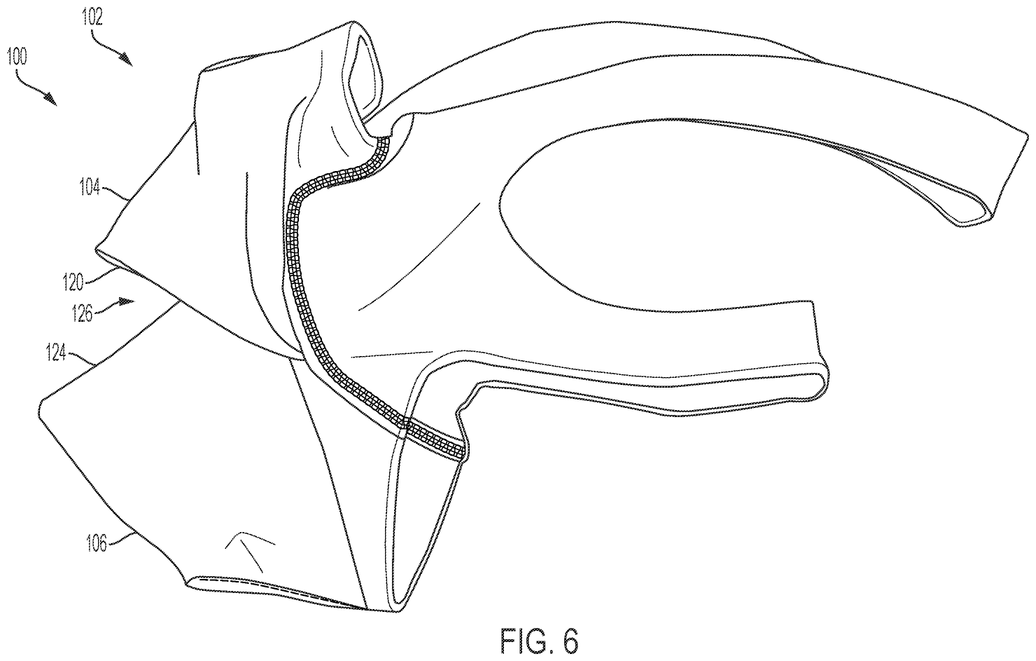

FIG. 5 illustrates the garment 102 with the face covering 100 in the closed configuration. FIG. 6 illustrates the garment 102 with the face covering 100 in an open configuration. That is, the upper portion 104 and the lower portion 106 are positioned such that at least a portion of the free lower edge 120 of the upper portion 104 is disposed superiorly relative to at least a portion of the free upper edge 124 of the lower portion 106. As such, in the open configuration the free lower edge 120 and the free upper edge 124 provide an opening 126 therebetween, and a mouthguard (not shown) may pass through the opening to enter or exit the mouth of a wearer. To facilitate receiving a mouthguard, one or more of the free lower edge 120, the free upper edge 124, and the opening may have a width in a transverse direction in a range of 5 inches to 7 inches, more specifically a range of 5.25 inches to 6.75 inches, more specifically a range of 5.5 inches to 6.5 inches, and even more specifically a range of 5.75 inches to 6.25 inches.

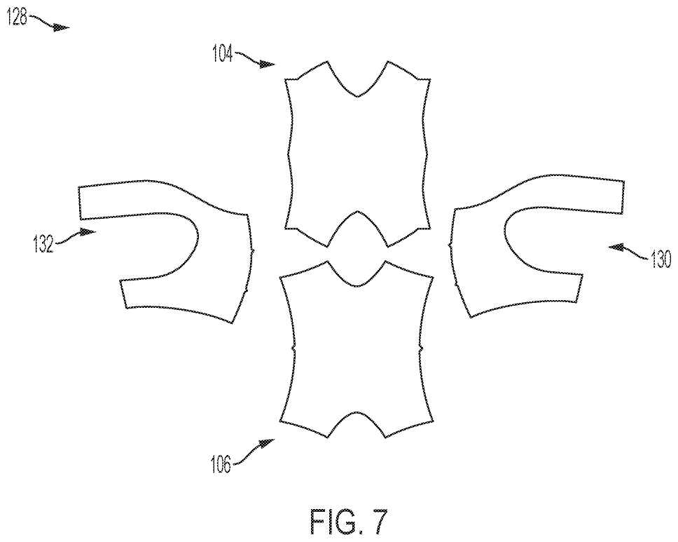

FIG. 7 illustrates a pattern 128 for forming portions of the garment 102. More specifically, the upper portion 104 and the lower portion 106 of the face covering 100 and a left portion 130 and a right portion 132 of the posterior portion 108 of the garment 102 may be cut from a sheet of material, following the pattern 128, and subsequently coupled to each other (for example, via stitching as described above). Face coverings and garments according to the present disclosure may comprise any of various appropriate materials, including stretchable fabrics. In some embodiments, upper portions and lower portion of face coverings according to the present disclosure are both formed from two layers of jersey material having water repellent and/or anti-microbial linings or properties.

Various other modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. A face covering configured to obscure the nose and the mouth of a wearer, the face covering comprising:
an upper portion comprising a free lower edge; and
a lower portion coupled to the upper portion, the lower portion comprising a free upper edge;
wherein the free lower edge and the free upper edge are relatively movable to provide an opening therebetween, the opening being configured to permit a mouthguard to pass through the face covering.

2. The face covering of claim 1, the free lower edge has a width in a transverse direction in a range of 5 inches to 7 inches.

3. The face covering of claim 1, wherein the free upper edge is disposed superiorly relative to the free lower edge.

4. A garment comprising the face covering of claim 1, the garment being at least one of a mask, a balaclava, a neck gaiter, and a shirt.

5. The garment of claim 4, wherein the garment comprises a posterior portion coupled to the face covering, the posterior portion configured to be disposed behind the head of the wearer.

6. A face covering configured to obscure the nose and the mouth of a wearer, the face covering comprising:
a lower panel; and
an upper panel partially overlapping the lower panel;
wherein the lower panel and the upper panel are relatively movable to provide an opening therebetween, the opening being configured to permit a mouthguard to pass through the face covering.

7. The face covering of claim 6, the opening has a width in a transverse direction in a range of 5 inches to 7 inches.

8. A garment comprising the face covering of claim 6, the garment being at least one of a mask, a balaclava, a neck gaiter, and a shirt.

9. The garment of claim 8, wherein the garment comprises a posterior portion coupled to the face covering, the posterior portion configured to be disposed behind the head of the wearer.

10. A face covering configured to obscure a nose and a mouth of a wearer, the face covering comprising:
a first fabric panel having a first free edge;
a second fabric panel having a second free edge, wherein the first free edge is positioned anteriorly of the second free edge in an overlapping manner, and wherein the first fabric panel and the second fabric panel are cooperatively positioned to obscure a nose and mouth of the wearer when in use, and wherein the first free edge and the second free edge are relatively movable to provide an opening therebetween, the opening being configured to permit a mouthguard to pass through the face covering; and
a posterior portion coupled to the first fabric panel and the second fabric panel, the posterior portion configured to be disposed behind the head of the wearer.

11. The face covering of claim 10, wherein the first fabric panel is disposed superiorly relative to the second fabric panel.

12. The face covering of claim 10, wherein the first fabric panel is disposed inferiorly relative to the second fabric panel.
